(19) United States
(12) Patent Application Publication
(10) Pub. No.: US 2025/0319520 A1
(43) Pub. Date: Oct. 16, 2025

(54) METHOD FOR ADDITIVE MANUFACTURING MACHINE AND PROCESS QUALIFICATION AND VERIFICTION

(71) Applicant: Baker Hughes Oilfield Operations LLC, Houston, TX (US)

(72) Inventors: Matthias Gieseke, Wedemark (DE); Nils Holzapfel, Wedemark (DE); Kevin Krueger, Hannover (DE); Thomas Dobrowolski, The Woodlands, TX (US)

(21) Appl. No.: 18/636,688

(22) Filed: Apr. 16, 2024

(51) Int. Cl. B22F 10/85; B22F 10/28; B22F 12/90; B23K 26/34; B33Y 10/00; B33Y 30/00; B33Y 50/00

(52) U.S. Cl. CPC B22F 10/85; B22F 10/28; B22F 12/90; B23K 26/34; B33Y 10/00; B33Y 30/00; B33Y 50/00

(57) ABSTRACT

Systems and methods for analyzing an additive manufacturing machine are disclosed. The methods include generating an object with Full Layer Exposure (FLE) on a build plate of an additive manufacturing machine. The methods also include capturing data for the object with FLE. The methods further include identifying defects in the object with FLE utilizing the data. The methods further include identifying defects in the additive manufacturing machine utilizing the defects in the object with FLE identified. The methods yet further include, in response to identifying a process defect, performing at least one action chosen from among causing at least one parameter of an attribute associated with the additive manufacturing process to be adjusted and issuing at least one alert defining the process defect, and in response to identifying a hardware defect of the additive manufacturing machine, issuing at least one alert defining the hardware defect.

### FIELD

The present disclosure relates generally to additive manufacturing machines, and more specifically to process qualification and verification of additive manufacturing machines.

### BACKGROUND

Beam based additive manufacturing machines, such as laser beam powder bed fusion (L-PBF) and electron beam powder bed fusion (E-PBF) are metal additive manufacturing technologies with a wide range of applications in the aerospace, medical, and energy industries. Flaws, defects, and other errors in the energy delivery system, the optics, gas flow, recoating, or in a setup of the build plate can result in defects in the products manufactured by the additive manufacturing machines.

The above-described background relating to beam based additive manufacturing machines is merely intended to provide a contextual overview of some current issues and is not intended to be exhaustive. Other contextual information may become apparent to those of ordinary skill in the art upon review of the following description of exemplary embodiments.

### BRIEF SUMMARY

In one illustrative embodiment, the present disclosure provides a method for analyzing an additive manufacturing machine for manufacturing one or more objects. The method includes generating an object with Full Layer Exposure (FLE) on a build plate of a beam based additive manufacturing machine. The method also includes capturing data for the object with FLE. The method further includes identifying defects in the object with FLE utilizing the data. The method further includes identifying defects in the additive manufacturing machine utilizing the defects in the object with FLE identified. The defects include at least one type of defect chosen from among a hardware defect of the additive manufacturing machine and an additive manufacturing process defect. The method yet further includes in response to identifying the additive manufacturing process defect, performing at least one action chosen from among causing at least one parameter of an attribute associated with the additive manufacturing process to be adjusted and issuing at least one process defect alert defining the additive manufacturing process defect.

In another illustrative embodiment, the present disclosure provides an additive manufacturing system. The additive manufacturing system includes an additive manufacturing machine, one or more processors, and a memory. The additive manufacturing machine includes a build chamber, a build plate, a material delivery system, and an energy delivery system. The build plate positioned in the build chamber and configured to support one or more objects being manufactured. The material delivery system configured to provide feedstock material to the build chamber. The energy delivery system configured to use a beam on the feedstock material to melt the feedstock material and form the one or more objects. The memory includes instructions, when executed, cause the one or more processors to: generate an object with Full Layer Exposure (FLE) on the build plate; capture data for the object with FLE; identify defects in the object with FLE utilizing the data; identify defects in the additive manufacturing machine utilizing the defects in the object with FLE identified, the defects including at least one type of defect chosen from among a hardware defect of the additive manufacturing machine and an additive manufacturing process defect; in response to identifying the additive manufacturing process defect, cause at least one parameter of an attribute associated with the additive manufacturing process to be adjusted; and in response to identifying a hardware defect of the additive manufacturing machine, issue at least one alert defining the hardware defect.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram of an additive manufacturing system in accordance with embodiments of the present disclosure;

FIG. 2 a flowchart of a method for analyzing an additive manufacturing machine for manufacturing one or more objects;

FIG. 3 is a schematic illustration of a solidified object with a Full Layer Exposure (FLE) on a build plate indicating visual;

FIG. 4 is a schematic illustration of melt pool of a simple FLE;

FIG. 5 is a schematic illustration of a damaged optical component corresponding to the melt pool data of FIG. 4;

FIG. 6 is a schematic illustration of melt pool data correlating to melting process defect of an additive manufacturing system; and

FIG. 7 is a schematic illustration of test verification of impact to material properties of an object corresponding to the melt pool data of FIG. 6.

### DETAILED DESCRIPTION

In various embodiments, the present disclosure relates to systems and methods for analyzing an additive manufacturing machine including qualification of the additive manufacturing machine and/or process verification of the additive manufacturing machine. The qualification and process verification may be performed simultaneously. As will be outlined in greater detail below, the qualification and/or process verification of the additive manufacturing machine includes generating an object with FLE, capturing data (hereinafter referred to as “FLE data”) from the object with FLE (e.g., data obtained from the melt pool or data obtained from the solidified object), identify defects in the object with FLE of the same or different settings utilizing the data, and identifying defects in the additive manufacturing machine and/or processes thereof utilizing the defects identified in the object with FLE. Data obtained from the melt pool (hereinafter referred to as “melt pool data”) may refer to any data collected regarding the melt pool with FLE using systems that capture images, a wide range of wavelengths emitted by the melt pool, or other similar types of data. Dependent on the system specific wavelengths are of more value. The typical wavelength spectrum to capture melt pool behavior is between 900 mm and 950 nm. The use of full layer exposure may significantly reduce the resources needed to qualify the additive manufacturing machine and/or quantify processes thereof by identifying weak spots and process deviations.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

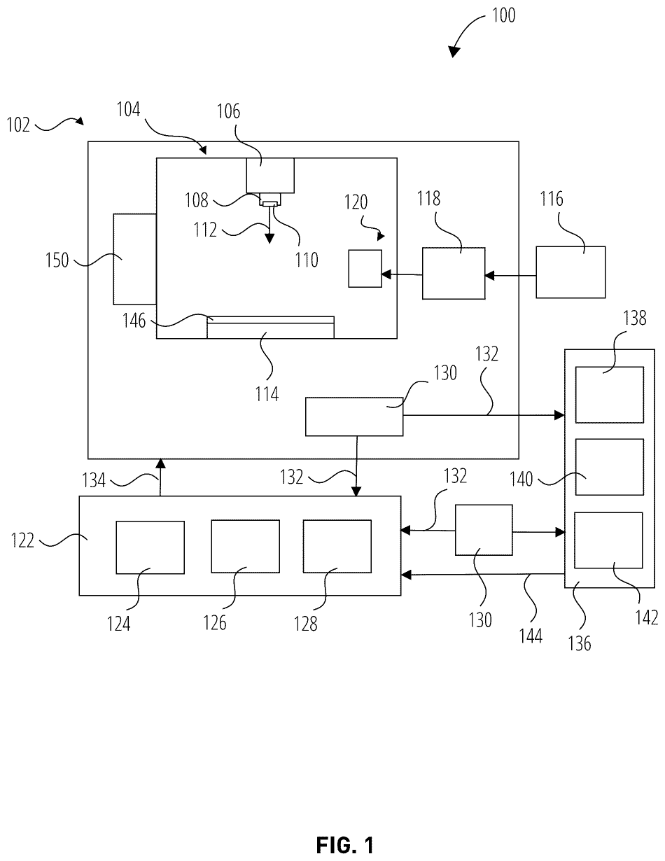

FIG. 1 is a block diagram of an additive manufacturing system 100 in accordance with embodiments of the present disclosure. The additive manufacturing system 100 includes an additive manufacturing machine 102 and controller 122 operably coupled to the additive manufacturing machine 102. In embodiments, the additive manufacturing machine 102 is a beam based additive manufacturing machine (e.g., laser beam powder bed fusion (L-PBF) and electron beam powder bed fusion (E-PBF), without limitation). The additive manufacturing machine 102 is adapted to receive a feedstock material 116 and manufacture one or more objects 146 using the feedstock material 116.

The additive manufacturing machine 102 includes a build chamber 104, a build plate 114, a material feeding mechanism 118, a material delivery system 120, an energy delivery system 106, and a gas flow system 150. The build plate 114 is positioned within the build chamber 104 and is adapted to be raised and lowered based on commands received by the additive manufacturing machine 102 from the controller 122. The build plate 114 provides a base for the fabrication of one or more objects 146 (e.g., metal components, without limitation) and is configured to support the one or more objects 146 being manufactured by the additive manufacturing machine 102.

The material feeding mechanism 118 is configured to receive the feedstock material 116 to be used in the additive manufacturing of the one or more objects 146. In some embodiments, the material feeding mechanism 118 is configured to provide the feedstock material 116 to the material delivery system 120, which in turn is configured to deliver the feedstock material 116 to the build plate 114 in the build chamber 104. In embodiments, the material delivery system 120 is configured to provide a feedstock material 116 that includes a powder, such as a metallic powder.

The energy delivery system 106 includes an energy delivery head 108 and is configured to emit a beam 112 onto the feedstock material 116 to melt the feedstock material 116 and to form the one or more objects 146. The energy delivery head 108 may be a laser head configured to produce a laser or an electron beam head configured to produce an electron beam. The energy delivery head 108 includes optical components 110 configured to direct the beam 112 towards the build plate 114. The optical components 110 include one or more lenses, mirrors, protective covers, and the like. The additive manufacturing machine 102 is configured to manufacture the one or more objects 146 on the build plate 114, layer by layer, as the feedstock material 116 is fed to the material feeding mechanism 118, delivered to the build plate 114 by the material delivery system 120, and melted by the beam 112.

The gas flow system 150 is configured to cause a gas to flow through the build chamber 104 and across the build plate 114. In various embodiments, a gas flow system 150 may not be present in the additive manufacturing machine 102 (e.g., additive manufacturing machines configured to perform additive manufacturing processes in a vacuum, without limitation).

The controller 122 is configured to control at least a portion of operation of the additive manufacturing machine 102. The controller 122 is configured to control the additive manufacturing machine 102 using control signals 134, including commands, configured to indicate to the additive manufacturing machine 102 specifics of operation. By way of non-limiting examples, the controller 122 is configured to control feeding of the feedstock material 116 into the material feeding mechanism 118, operation of the material delivery system 120, operation of the energy delivery system 106, other operations, or combinations thereof.

The controller 122 includes a processor 124, memory 126, and one or more storage devices 128. The memory 126 stores computer-executable instructions that, when executed, cause the processor 124 to control the additive manufacturing machine 102 in any manner disclosed herein, to perform any relevant method as disclosed herein, or to produce one or more objects 146. The storage device 128 is configured to store manufacturing instructions, input factors for the manufacturing process, and the like. While the controller 122 is described as separate from the additive manufacturing machine 102, in some embodiments, the controller 122 is integrated into the additive manufacturing machine. Alternatively, the additive manufacturing machine includes a separate processor, memory, and one or more storage devices 128 configured to operate the various components of the additive manufacturing machine 102 based at least in part on control signals received from the controller 122.

The additive manufacturing system 100 includes a monitoring system 136 and monitoring devices 130. As will be described in further detail below, the monitoring system 136 is configured to perform one or more of monitoring the additive manufacturing machine 102, verifying the additive manufacturing machine 102, qualifying processes of the additive manufacturing machine 102. The monitoring system 136 includes a processor 138, a memory 140, and one or more storage devices 142. The memory 140 stores computer-executable instructions that, when executed, cause the processor 138 to obtain data from the storage devices 128 via monitoring signals 132 and to perform any relevant method as disclosed herein to monitor the additive manufacturing machine 102, verify the additive manufacturing machine 102, and qualify processes of the additive manufacturing machine 102. The storage device 142 is configured to store instructions for monitoring the additive manufacturing machine 102, verifying the additive manufacturing machine 102, and qualifying processes of the additive manufacturing machine 102, data obtained from the monitoring devices 130, and the like.

While the monitoring system 136 is shown as separate from the controller 122 and the additive manufacturing machine 102, in some embodiments, the monitoring system 136 is integrated into the controller 122, the additive manufacturing machine 102, or a combination thereof. The monitoring system 136 may operate in-line with the additive manufacturing machine 102 and receives data from the monitoring devices 130 during operation of the additive manufacturing machine 102, may operate off-line from the additive manufacturing machine 102 and may receive data from monitoring devices 130 capturing data from the solidified object (hereinafter referred to as “solidified object data”), or a combination thereof.

The monitoring devices 130 may be separate from the additive manufacturing machine 102, integrated into the additive manufacturing machine 102, or a combination thereof. The monitoring devices 130 include at least one device chosen from among a camera (e.g., off-axis Complementary Metal-Oxide-Semiconductor (CMOS), without limitation), a sensor (e.g., on-axis thermal sensor/pyrometer, without limitation), a detector (e.g., a photodetector, without limitation), and a post processing measurement device (e.g., laser scanning microscope, white light interferometer, an X-ray, and Computed Tomography (CT), without limitation).

The monitoring devices 130 may be configured to send FLE data to the monitoring system 136 and the controller 122 via monitoring signals 132. In some embodiments, the monitoring devices 130 may be configured to send FLE data to the monitoring system 136, and the monitoring system 136 is configured to send monitoring data 144 to the controller 122.

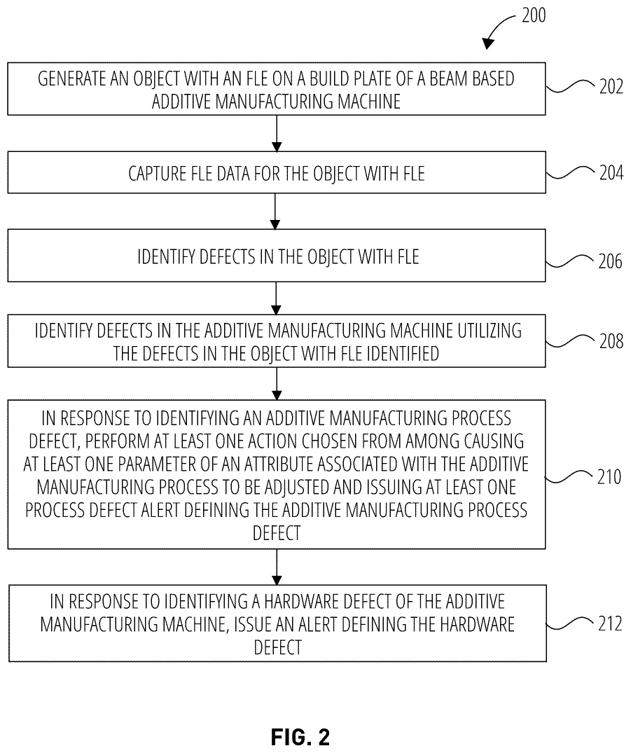

FIG. 2 is a flowchart of a method 200 for analyzing an additive manufacturing machine for manufacturing one or more objects. The analyzing includes qualifying the additive manufacturing machine and/or verifying processes thereof. The method includes generating an object with Full Layer Exposure (FLE) on a build plate of a beam based additive manufacturing machine at act 202. The beam based additive manufacturing machine may be chosen from among an L-PBF and an E-PBF.

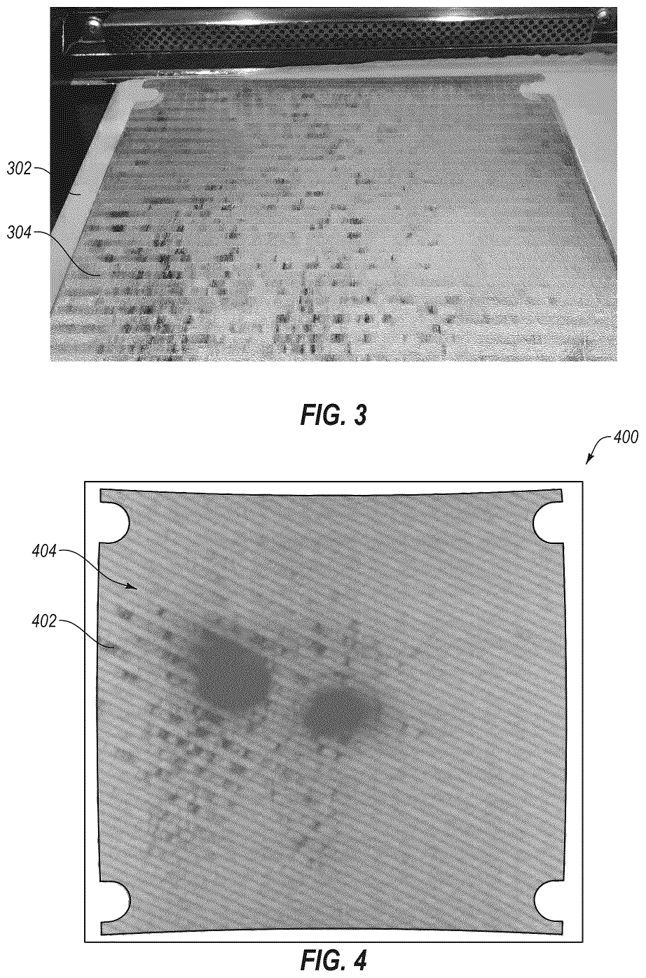

FIG. 3 is a schematic illustration of a solidified object with FLE on a build plate 302 indicating visual defects. As can be seen in FIG. 3, in some embodiments, an object with FLE is formed from a melt pool 304 that substantially covers the complete print area of the build plate 302 where the complete print area of the build plate 302 includes any area on the build plate 302 that the additive manufacturing machine is configured to melt feedstock and produce a portion of a component. In other embodiments, FLE is applied to a region of interest and the region of interest is fully covered on the build plate 302. In various embodiments, FLE includes producing an object with low height (e.g., an object with a number of layers chosen from one layer to about five layers, without limitation) substantially covering a complete print area of the build plate 302. FLE may also include producing at least a substantially fully molten layer at the first layer of the object that substantially covers the complete print area of the build plate 302 or to that substantially covers the complete region of interest in the print area. Production may be continued on the FLE layers if quality verification is satisfactory.

Referring to FIG. 2, generating an object FLE on a build plate of a beam based additive manufacturing machine may include utilizing a variety of melting conditions while producing one or more layers of the object with FLE. Utilizing a variety of melting conditions may include changing attributes associated with the additive manufacturing process while generating the one or more layers of the object with FLE. The attributes may be chosen from among laser power, laser speed, laser focus, hatch spacing, layer thickness, gas flow velocity, plate temperature, recoating velocity, recoating method, printing direction (right to left, left to right etc.), printing strategy (stripes, chess, meander, etc.), and other minor parameters.

The method 200 also includes capturing FLE data (e.g., melt pool data, solidified object data, or both) for the object with FLE at act 204. Act 204 may include at least one form of data capture chosen from among in-process data capture (e.g., utilizing monitoring devices 130 of the monitoring system 136 to capture melt pool data while the object with FLE is produced, such as cameras, sensors, and detectors, without limitation) and post-process data capture (e.g., utilizing a laser scanning microscope, white light interferometry, computerized tomography, and X-Ray, without limitation). By utilizing both in-process and post-process data capture for an object with FLE, homogeneity of an additive manufacturing process over a complete build plate can be quantified. Capturing in-process melt pool data may include capturing a data set for each layer of the object with FLE. In some embodiments, act 204 includes at least in-process data capture. The FLE data may include images of each layer of the object with FLE, structural and chemical compositions, temperatures of the melt pool during the manufacturing process, and the like.

The method 200 further includes identifying defects in the object with FLE utilizing the FLE data at act 206. The defects may include defective areas within the melt pool or solidified object (e.g., inadequate welding, inadequate melting (e.g., poor melting quality), burn marks, shrinkage, deformation, and improper laser overlaps, without limitation). By utilizing an object with FLE, the method 200 covers the whole print area or whole region of interest, and thus, the positioning-dependency of a part or sample is not relevant to the method.

The method 200 further includes identifying defects in the additive manufacturing machine utilizing the defects in the object with FLE identified at act 208. The defects may include at least one type of defect chosen from among a hardware defect of the additive manufacturing machine and an additive manufacturing process defect/melting process defect. Hardware defects may be chosen from among damage (e.g., burn marks, scratches, cracks, without limitation) and pollution on one or more components of the additive manufacturing machine. The components may be chosen from among lenses, mirrors, protective covers, and the build chamber of the additive manufacturing machine. An additive manufacturing process defect may be inadequate attributes (e.g., attribute value too high or too low, without limitation) utilized during the additive manufacturing process chosen from among laser power, laser speed, laser focus, hatch spacing, layer thickness, gas flow velocity, plate temperature, and recoating velocity. In various embodiments, act 208 includes utilizing the defective areas identified in the object with FLE to identify one or more defects in the additive manufacturing machine.

With continued reference to FIG. 2, identifying defects in the additive manufacturing machine utilizing defects in the object with FLE identified may include identifying a pattern of the defective areas and utilizing the pattern to identify the defects in the additive manufacturing machine. In some of these embodiments, the pattern identified in the defective areas for each layer of the object is compared to the pattern identified in the defective areas in other layers of the object.

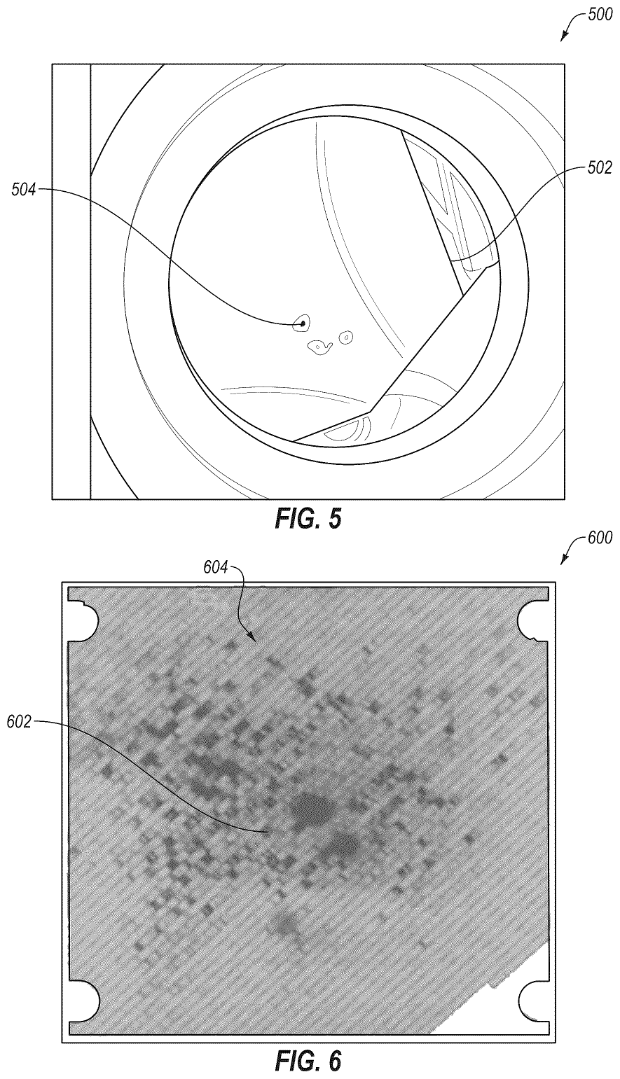

FIG. 4 is a schematic illustration of melt pool data 400 of a simple FLE. FIG. 5 is a schematic illustration of a damaged optical component 500 corresponding to the melt pool data of FIG. 4. Referring to FIG. 4 and FIG. 5, the pattern 404 of defective areas 402 grouped together and that is consistent over the melt pool data for each layer of the object identifies a hardware defect. As illustrated in FIG. 5, the hardware defect may be damage 504 to the lens 502 of the optical component 500.

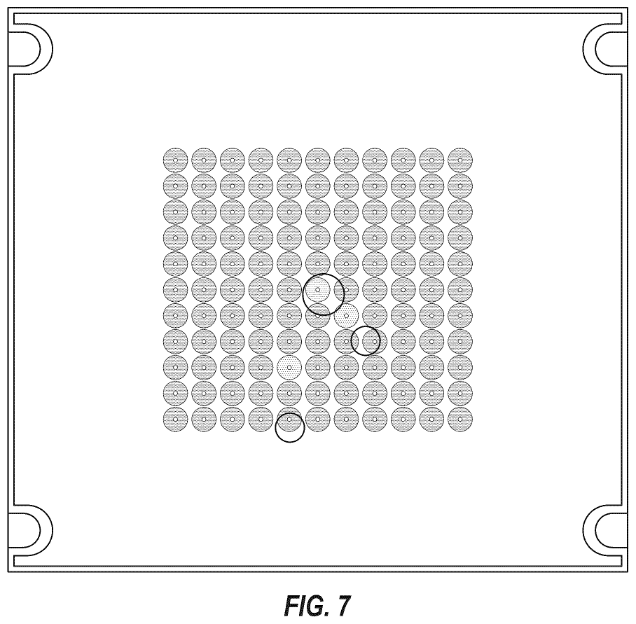

FIG. 6 is a schematic illustration of melt pool data 600 correlating to both an additive manufacturing process defect and a hardware defect of an additive manufacturing machine. FIG. 7 is a schematic illustration of test verification of impact to material properties of an object corresponding to the melt pool data of FIG. 6. Referring to FIG. 6 and FIG. 7, the pattern 604 of defective areas 602 scattered about the melt pool data 600 and inconsistent over the melt pool data for each layer of the object identifies an additive manufacturing process defect. For example, the melt pool data 600 illustrates melt pool data for a layer of an object with insufficient welding resulting from an additive manufacturing process defect and a burn mark resulting from a hardware defect. As can be seen in FIG. 7, the defective areas 602 identified in the melt pool data correlate to defective areas of the object.

Returning to FIG. 2, identifying defects in the additive manufacturing machine utilizing defects in the object with FLE identified may include comparing patterns of defective areas of the object with FLE for at least one layer to previously obtained patterns of defective areas for another object with known defects. These patterns may include, for example, keyholing, balling, and lack of fusion, each of which may be associated with an additive manufacturing process defect or a hardware defect of the additive manufacturing machine.

In various embodiments, act 204 includes capturing an image of each layer of the object with FLE, act 206 includes identifying the defective areas in the image, and act 208 includes identifying a pattern in of the defective areas. In some of these embodiments, act 206 includes performing one or more image processing techniques to enhance features of each image captured. For example, the method may include performing at least one technique selected from among edge detection, histogram equalization, noise reduction, edge enhancement, image sharpening, signal boosting, and signal dampening. Act 206 may include applying any conventionally known convolution matrix to at least part of the one or more images to enhance features of the image, (e.g., possible defects represented in the image, without limitation). Act 206 may include extracting one or more features from the one or more images. For example, act 206 may include extracting features using any extraction technique, such as convolution, Rectified Linear Unit transformations, and pooling.

In some of these embodiments, each image is a greyscale image or converted to a greyscale image and the patterns are identified by comparing greyscale values within the image. The greyscale values for defective areas may be different depending on the type of defect of the additive manufacturing machine.

In some embodiments, acts 206 and 208 are performed using a machine learning model. For example, a classification model (e.g., a machine learning model) may be trained and configured to identify a defect of the object with FLE and the additive manufacturing machine, at least in part, on FLE data associated with known defects (e.g., patterns within images, without limitation). The classification model may be trained using decision tree learning, regression trees, boosted trees, gradient boosted trees, multilayer perceptron, one-vs-rest, gradient boosted tree, k-nearest neighbor association rule learning, a neural network, deep learning, pattern recognition, or any other type of machine learning. As a specific example, one iteration of an unsupervised training process may include printing test objects with FLE using different combinations of varied parameters to create FLE data for a given material used in the printing process and printing objects with additive manufacturing machines that have known hardware defects to create FLE data for given hardware defects. A machine learning method (e.g., an unsupervised machine learning method such as clustering or manifold learning) may then be used to form classes of defect types based on features extracted from the FLE data using the machine learning method. An operator may then manually examine the FLE data to confirm the accuracy of at least one defect classified by the machine learning method. A machine learning model may then be generated or updated responsive to the detected defects and/or the accuracy findings of the operator. This process may be repeated any number of times until a desirable classification model is achieved.

As another example, a classification model may be achieved through a supervised training process. For instance, one iteration of a supervised training process may include printing test objects with FLE using different combinations of varied parameters to create FLE data for a given material used in the printing process and printing objects with additive manufacturing machines that have known hardware defects to create FLE data for given hardware defects. The test objects with FLE and FLE data may then be manually examined to identify defects and assign identified defects into classes. The identified classes may then be used to generate or train a classification model based on the identified classes and the features present in the FLE data. For example, a machine learning model may be trained based on labeled classes through dimensionality reduction techniques and performing a feature selection process on the identified features in the FLE data to identify distinguishing characteristics of different defect types. This process may be repeated any number of times until a desirable classification model is achieved. Moreover, the classification model may be continually trained during operation of the additive manufacturing system with or without manual feedback.

With continued reference to FIG. 2, the method 200 yet further includes, in response to identifying an additive manufacturing process defect, performing at least one action chosen from among causing at least one parameter of an attribute associated with the additive manufacturing process to be adjusted and issuing at least one process defect alert defining the additive manufacturing process defect at act 210. In some embodiments, only one of the actions above is performed. In other embodiments, only the other of the actions is performed. The at least one parameter may be one or more values utilized to control the attribute, a minimum threshold value for the attribute, or a maximum threshold value for the attribute. In various embodiments, the method 200 is utilized to test the limits of at least one attribute associated with the additive manufacturing process by changing the at least one attribute during act 202 and determining at which point the attribute values resulted in an identified defect during act 206, and the at least one parameter changed at act 210 is a threshold value of the attribute. The limits to attributes may include maximum layer thickness, build up rate, and minimum or maximum gas flow speed. In some embodiments, the at least one software defect alert is chosen from among a message on a display of the additive manufacturing system, a notification sent to an operator, an email, and a report.

In various embodiments, the method 200 includes causing a second object to be produced by the additive manufacturing machine after causing the at least one attribute associated with the additive manufacturing process to be adjusted. The second object may be chosen from among another object with FLE and a component for an industrial process. In some embodiments, the second object is printed directly on the object with FLE.

The method 200 may further include, in response to identifying a hardware defect of the additive manufacturing machine, issuing at least one alert defining the hardware defect at act 212. In some embodiments, the at least one hardware defect alert is chosen from among a message on a display of the additive manufacturing system, a notification sent to an operator, an email, and a report. In various embodiments, the process defects alerts and the hardware defect alerts are combined and sent as a single alert to a user.

The various illustrative logical blocks, modules, and circuits described in connection with the embodiments of the additive manufacturing system 100, and in particular, the controller 122 and the monitoring system 136, disclosed herein, may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

Although the present disclosure has been illustrated and described herein with reference to various embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method for analyzing an additive manufacturing machine, the method comprising:
generating an object with Full Layer Exposure (FLE) on a build plate of a beam based additive manufacturing machine, the object with FLE formed from a melt pool that substantially covers one of: a complete print area of a built plate of the additive manufacturing machine; and a complete region of interest in the print area;
capturing data for the object with FLE;
identifying defects in the object with FLE utilizing the data;
identifying defects in the additive manufacturing machine utilizing the defects in the object with FLE identified, the defects including at least one type of defect chosen from among a hardware defect of the additive manufacturing machine and an additive manufacturing process defect;
in response to identifying the additive manufacturing process defect, performing at least one action chosen from among causing at least one parameter of an attribute associated with the additive manufacturing process to be adjusted and issuing at least one process defect alert defining the additive manufacturing process defect; and
in response to identifying a hardware defect of the additive manufacturing machine, issuing at least one alert defining the hardware defect.

2. The method of claim 1, wherein generating the object with FLE on the build plate including utilizing a variety of melting conditions while producing one or more layers of the object with FLE.

3. The method of claim 2, wherein utilizing the variety of melting conditions includes changing attributes associated with the additive manufacturing process while generating the one or more layers of the object with FLE, the attributes chosen from among: laser power; laser speed; laser focus; hatch spacing; layer thickness; gas flow velocity; plate temperature; recoating velocity; and a recoating method.

4. The method of claim 3, wherein changing attributes and identifying the defects includes determining at which point the attribute values resulted in an identified defect, and wherein causing the at least one parameter of the attribute associated with the additive manufacturing process to be adjusted includes changing a threshold value of the attribute.

5. The method of claim 1, wherein capturing the data for the object with FLE includes capturing a data set for each layer of the object with FLE in-process while the object with FLE is produced utilizing a monitoring device of a monitoring system.

6. The method of claim 1, wherein the hardware defect is chosen from among damage and pollution on one or more components of the additive manufacturing machine.

7. The method of claim 1, wherein the additive manufacturing process defect includes one or more inadequate attributes utilized during the additive manufacturing process chosen from among laser power, laser speed, laser focus, hatch spacing, layer thickness, gas flow velocity, plate temperature, and recoating velocity.

8. The method of claim 1, wherein identifying defects in the additive manufacturing machine utilizing the data includes identifying defective areas within the FLE and utilizing the defective areas identified to identify one or more defects in the additive manufacturing machine.

9. The method of claim 8, wherein utilizing the defective areas identified to identify the one or more defects in the additive manufacturing machine includes comparing patterns of the defective areas for at least one layer of the object with FLE to previously obtained patterns of defective areas from another object with known defects.

10. The method of claim 1, wherein capturing the data for the object with FLE includes capturing an image of each layer of the object with FLE, identifying defects in the object with FLE utilizing the data includes identifying the defective areas in the image, and identifying defects in the additive manufacturing machine utilizing the defects in the object with FLE identified includes identifying a pattern in of the defective areas.

11. The method of claim 10, wherein each image is chosen from among a greyscale image and a converted greyscale image and the pattern is identified by comparing greyscale values within the image.

12. The method of claim 1, further comprising causing a second object to be produced by the additive manufacturing machine after causing the at least one attribute associated with the additive manufacturing process to be adjusted, wherein the second object is printed directly on the object with FLE.

13. An additive manufacturing system, comprising:
an additive manufacturing machine including;
a build chamber;
a build plate positioned in the build chamber and configured to support one or more objects being manufactured;
a material delivery system configured to provide feedstock material to the build chamber;
an energy delivery system configured to use a beam on the feedstock material to melt the feedstock material and form the one or more objects;
one or more processors; and
memory including instructions, when executed, cause the one or more processors to:
generate an object with Full Layer Exposure (FLE) on the build plate, the object with FLE formed from a melt pool that substantially covers one of: a complete print area of a built plate of the additive manufacturing machine; and a complete region of interest in the print area;
capture data for the object with FLE;
identify defects in the object with FLE utilizing the data;
identify defects in the additive manufacturing machine utilizing defects in the object with FLE identified, the defects including at least one type of defect chosen from among a hardware defect of the additive manufacturing machine and an additive manufacturing process defect;
in response to identifying the additive manufacturing process defect, perform at least one action chosen from among causing at least one parameter of an attribute associated with the additive manufacturing process to be adjusted and issuing at least one process defect alert defining the additive manufacturing process defect; and
in response to identifying a hardware defect of the additive manufacturing machine, issue at least one alert defining the hardware defect.

14. The additive manufacturing system of claim 13, further comprising a monitoring device configured to capture the data for the object with FLE.

15. The additive manufacturing system of claim 14, wherein the monitoring device is configured to capture a data set for each layer of the object with FLE in-process while the object with FLE is produced.

16. The additive manufacturing system of claim 15, wherein the monitoring device is configured to capture an image of each layer of the object with FLE, and wherein identifying defects in the additive manufacturing machine utilizing the data includes identifying the defective areas in the image and identifying a pattern in of the defective areas.

17. The additive manufacturing system of claim 16, wherein each image is chosen from among a greyscale image and a converted greyscale image and the pattern is identified by comparing greyscale values within the image.

18. The additive manufacturing system of claim 15, wherein the hardware defect is chosen from among damage and pollution on one or more components of the additive manufacturing machine.

19. The additive manufacturing system of claim 18, wherein the energy delivery system includes a lens, a mirror, and a protective cover, and wherein the one or more components is chosen from among the lens, the mirror, the protective cover, and the build chamber.

20. The additive manufacturing system of claim 13, wherein the memory includes instructions, when executed, cause the one or more processors to cause a second object to be produced by the additive manufacturing machine after causing the at least one attribute associated with the additive manufacturing process to be adjusted, wherein the second object is printed directly on the object with FLE.
